(19) United States
(12) Patent Application Publication
(10) Pub. No.: US 2006/0222047 A1
(43) Pub. Date: Oct. 5, 2006

(54) Method and apparatus for localized infrared spectrocopy and micro-tomography using a combination of thermal expansion and temperature change measurements

(76) Inventor: Michael Reading, Norwich (GB)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/398,450

(22) Filed: Apr. 5, 2006

Related U.S. Application Data
(60) Provisional application No. 60/668,077, filed on Apr. 5, 2005.
(60) Provisional application No. 60/688,904, filed on Jun. 9, 2005.

(51) Int. Cl. G01K 1/16

(52) U.S. Cl. 374/120

(57) ABSTRACT

A method and a system for generating a high spatial resolution multi-dimensional image representing the chemical composition of a sample. Highly localized IR light is used to cause the heating and thermal expansion of the sample. Modulating this IR light will cause this effect to take place at various depths of the material. The method and system of the present invention are used to generate a chemical profile of the sample using a combination of: (i) measurements of the thermal expansion and temperature change caused by absorbing IR radiation together; and (ii) measurements of the thermal expansion properties and thermal properties (such as thermal diffusivity and conductivity) of sites on the surface of the sample and the material surrounding it.

### CROSS-REFERENCE TO RELATED APPLICATIONS

The present invention claims the benefit of U.S. Provisional Patent Application Ser. No. 60/668,077, filed Apr. 5, 2005, entitled “Method And Apparatus for Localized Infrared Spectroscopic Microtomography Combined With Scanning Probe Microscopy,” and Ser. No. 60/688,904, filed Jun. 9, 2005, entitled “Method And Apparatus for Localized Infrared Spectroscopic Microtomography Using A Combination Of Thermal Expansion and Temperature Change Measurements.” The content of both of the above-mentioned application is incorporated by reference herein.

### BACKGROUND OF THE INVENTION

Techniques for the photothermal characterization of solids and thin films are widely used, as is described by D. P. Almond and P. M. Patel, “Photothermal Science and Techniques”, Chapman and Hall (London and New York, 1996). Recently the value of adding spatial resolution to these techniques has become of high technical interest in the general area of electronic and optical devices. Methods originally employed suffered from the limitations imposed by the finite optical wavelengths of the detection systems used. As a result, these methods have not been able to accomplish high spatial resolution.

However, if a miniature thermal detector is placed very close to the sample the spatial resolution of the measurement is governed by the dimensions of the probe and its proximity to the surface of the sample not the wavelength of the incident radiation, this is then called a “near-field” measurement. In this way, high spatial resolution can be achieved for thermal imaging.

Near field measurements and imaging can be achieved with a Scanning Probe Microscope. In the most frequently used version of this form of microscopy, a sharp probe is brought in close proximity to the surface of a sample. Some interaction takes place between the probe and the sample. This interaction is monitored as the probe is scanned over the surface. An image contrast is then computer generated. The image contrast represents variations of some property or properties (e.g., physical, mechanical, etc.) of the sample across the scanned area. One such probe microscope is the Atomic Force Microscope (AFM).

In conventional AFM, the degree of bending of the probe is controlled by a feedback system. In one version of AFM the feedback system keeps constant the degree of bending and, therefore, the force between the probe and the surface of the sample. The probe height is monitored, and provides the data that is used to create image contrast which represents the topography of the scanned area. In scanning thermal microscopy (SThM) the usually insert probe used for AFM is replaced with a thermal probe, for example one type of such a probe is an elongated loop of Wollaston wire, shaped in the form of a cantilever whose end forms the resistive element. The resistance of that element varies with temperature. Conversely, its temperature can be set by passing a current of appropriate value through it. A mirror is attached across the loop allowing for the contact force of the element on the sample to be held constant, as in conventional atomic force microscopy, while the probe is scanned across the surface of the sample. In one mode of use a constant voltage is applied to the tip and changes in resistance are measured as it is moved over the surface. This form of microscopy allows thermal properties such as thermal conductivity to be mapped on a sub-micron scale. Modulation of the voltage (and so current and temperature) can also be used when imaging and thus provide an image whose contrasts is related to the variations in thermal diffusivity across a scanned area. When using modulation, the time-varying current through the resistive elements generates thermal waves in the sample.

Recently this form of probe microscopy was greatly enhanced by allowing for the use of the thermal probe as a means of performing local thermal analysis. This has given rise to a family of techniques collectively known as microthermal analysis. An image is acquired as described above and then a point is selected for analysis. The probe is moved to this point, a force is applied and the temperature is increased linearly with time, a temperature modulation can be added if required. The probe placed on the sample can be used in conjunction with a reference probe to create a differential signal. The differential signal is then used to produce localized analysis plots of heat flow and amplitude and phase data for the modulation versus temperature. These provide calorimetric information at a specific position on the sample. In this way, localized thermal analysis on a very small scale became possible, including micro-calorimetric analysis and micro-thermomechanical (static and dynamic) analysis. Local chemical analysis is also achieved by heating the tip sufficiently to cause local pyrolysis with subsequent analysis of the evolved gases by conveying the gases directly into a mass spectrometer by suction for example or, alternatively, trapping the gas on a sorbent or a cold finger then releasing it into a gas chromatography instrument is possible with a mass spectrometer as the detector. (See U.S. Pat. No. 6,405,137 to Michael Reading). That invention is described in Price et al. 1999 International Journal of Pharmaceutics, and in Price et al. 1999 Proceedings of the 27th Conference of the North American Thermal Analysis Society.

PhotoThermal Micro-Spectroscopy (PTMS) is a technique that exploits the ability of the type of thermal probe described above and that is used for SThM to detect the local temperature variations caused by the absorption of infra red (IR) radiation. This is the only near-field technique to have, so far, provided a full IR spectrum. PTMS has the same well established ability to depth profile afforded by photoacoustic spectroscopy (because the photoacoustic measurement provides non-localized information equivalent to PTMS). PTMS is reviewed in Hammiche et al., Progress in Near-Field Photothermal Infra-Red Microspectroscopy, Journal of Microscopy, 213 (2), 2004, 129-134, hereinafter “Hammiche 2004.” Another technique described in this publication uses the thermal expansion caused by the absorption of IR radiation to measure an IR spectrum. In summary, Hammiche 2004 describes how the measurement of local temperature variations detected with a thermal probe and also how thermal expansion caused by absorption of IR radiation measured with a conventional AFM probe can both be used to measure local IR spectra. Hammiche 2004, however, does not teach or suggest creating a multidimensional image using multiplicity of modulations at different frequencies.

Furthermore, measurement of local thermal expansion properties by using AC (Alternating Current) and DC (Direct Current) thermal imaging are described in Hammiche et al., “Highly localised thermal mechanical and spectroscopic characterisation of polymers using a miniaturised thermal probe”, J. Vac. Sci. Technol. B 18(3), May/June 2000, 1322-1332, hereinafter “Hammiche 2000.” Hammiche 2000, however, does not teach or suggest thermal tomography.

Thermal imaging has been achieved on a scale of tens of nanometers, and calculations show that this should also be possible with this form of IR microscopy. Accordingly, the recently developed U.S. Pat. No. 6,260,997 to Claybourn et al. is incorporated by reference herein. That invention has been reviewed in Hammiche 2004 and relates to measuring infra red spectra using a thermal probe. While Claybourn teaches sub-surface thermal imaging using an infra red source, Claybourn does not teach or suggest chemical multidimensional tomography.

The photothermal measurement described above is related to photoacoustic FITR spectroscopy (PAS). Though not a near-field technique, it is well-established and has been commercially available for many years. In this photoacoustic method, it is the acoustic waves generated by heating the gas immediately adjacent to the surface that are detected in the far field by a microphone, whereas in the micro-thermal technique the surface temperature changes engendered by the IR radiation are measured directly by the thermal probe. One application of PAS is depth profiling. As described in Almond, et al., “Photothermal Science and Techniques,” page 15, Chapman and Hall (London 1996), the penetration depth of each thermal wave is proportional to the square root of the thermal diffusivity of the sample divided by the frequency of the applied temperature wave. Thus the higher frequency thermal modulations become more quickly attenuated as a function of depth. FIG. 1 illustrates this effect with a bi-layer sample of Mylar on top of a Polycarbonate substrate. FIG. 1 shows the IR spectrum versus wave number as a function of increasing frequency of modulation of the IR light. The frequency of the modulation of the incident radiation is changed by changing the mirror speed in the spectrometer. As the frequency is increased, the depth sampled is less. In other words, at the lower frequencies, the spectrum contains a greater contribution from the material located deeper in the sample. The limitation of photoacoustic spectroscopy (PAS) is that it measures the response of the whole surface, it does not provide images and thus no publications on this method teach how tomographic reconstruction of a 3D image can be achieved.

As discussed above, the limitation of PAS is that it is not spatially resolved in the x and y planes. Furthermore, in the general case where a complex or unknown sample is being studied, the data on the thermal properties of the materials being used is lacking, meaning that calculations of actual depths penetrated are approximate at best. With the micro-thermal approach the potential clearly exists to obtain the relevant measurements of properties like thermal diffusivity at the same point by using DC and AC thermal imaging possibly at a variety of frequencies. The depth penetrated by the thermal wave in AC thermal imaging can be controlled because it is possible to image at a variety of frequencies. The depth of penetration of a thermal wave decreases with increasing frequency (in the way as in the PAS example described above), so that the modulation frequency of the time-varying current is functionally related to the depth below the surface of the sample at which an image of the sample is desired. A sub-surface image is thus generated. The depth of material below the sample surface that is contributing to the image can be controlled by suitably choosing the temperature modulation frequency. U.S. Pat. No. 6,491,425 to Hammiche et al. describes how near-field thermal AC imaging can provide sub-surface information on structure on the basis of differences in thermal properties, using a heated tip whose temperature is modulated at different frequencies. This concept has been extended to tomography and the necessary software has been developed. A tomographic reconstruction algorithm has been implemented by Smallwood et al. (Thermochimica Acta 2002). They succeeded in creating one three dimensional image using ideal computer generated data as the starting point. No successful tomography with experimental data was achieved.

In summary, U.S. Pat. No. 6,491,425 to Hammiche et al. describes how near-field thermal AC thermal imaging can provide 3D information on structure on the basis of differences in thermal properties using a heated tip modulated at different frequencies. This has been further explored in Smallwood et al. (thermochimica Acta 2002) who attempted full tomography i.e. the generation of accurate detailed 3D images (rather than images that contain 3D information). However, the teachings of Smallwood et al. and Hammiche '425 are limited to providing images of thermal properties. Neither Smallwood, Hammiche '425, nor the combination thereof, teaches or suggests chemical multidimensional tomography. The literature of PAS, and Claybourn et al. together with the related literature on PTMS show that chemical information can be obtained in the x, y and z planes. However, this literature does not teach or suggest how detailed accurate tomographic images can be obtained.

As appreciated by those skilled in the art, multidimensional tomography is a method of producing a three-dimensional image of the internal structures of a solid object by the observation and recording of the differences in the effects on the passage of waves of energy impinging on the object. Generating multidimensional tomography of a sample requires solving an inverse problem of reconstructing the measured data to obtain a structural and/or chemical profile of the sample. Unlike other inverse problems that merely relate to using a heater on the surface of the sample (as discussed by Smallwood), the version of chemical tomography according to one embodiment of this invention involves solving a new inverse problem where the heat change and the thermal expansion generated by absorbing radiation that is dissipated by a particle or particles within the sample is detected by means of a near field probe or probes. The solution of this new inverse problem is used to generate high spatial resolution map of the chemical properties of a sample. The above-cited references do no teach or suggest a solution to this technical problem.

### BRIEF SUMMARY OF THE INVENTION

The present invention relates to a method and apparatus for measuring, at a high spatial resolution, subsurface chemical properties of a sample by subjecting it to a modulated IR light and measuring the temperature change and the physical expansion of the sample as a result of IR absorption. The depth-sensitive chemical information collected from these measurements is used to create a three-dimensional (3D) chemical tomographical reconstruction of the sample.

In one embodiment of the present invention, a method and system are used to generate a chemical profile of the sample using a combination of the following measurements:
(i) Generating thermal images of a sample using a thermal probe or probes in both DC and AC imaging modes at a variety of modulation frequencies;
(ii) Simultaneously with step (i), thermal expansion caused by the temperature modulation is measured so that images of thermal expansion are generated;
(iii) the sample is exposed to IR radiation at different wavelengths within the IR spectrum, wherein at each wavelength the radiation intensity is modulated at different frequencies, and images of local temperature changes caused by absorbing the IR radiation and local thermal expansion caused by absorbing IR radiation are generated simultaneously; and
(iv) the data from steps (i), (ii) and (iii) are used in an algorithm that solves the inverse problem that enables a high resolution 3D tomographic reconstruction of chemical information to be achieved.

As discussed above the version of chemical tomography according to one embodiment of this invention involves solving a new inverse problem where the heat change and the thermal expansion generated by absorbing radiation that is dissipated by a particle or particles within the sample is detected by means of a near field probe.

In another embodiment of the present invention, a scanning probe microscopy method and system are used to perform localized infrared spectroscopic micro-tomography, at a spatial resolution that is at the nanometers scale. The sample is exposed to infrared radiation. The resulting temperature rise of an individual region in the sample depends on the particular molecular species present, as well as the range of wavelengths present in the infrared beam. These individual temperature differences are detected by a miniature thermal probe. This probe is mounted in a scanning thermal microscope that is used to generate multiple surface and sub-surface images of the sample, such that the image contrast corresponds to variations in either surface topography, thermal diffusivity, coefficient of thermal expansion, and/or chemical composition.

In yet another embodiment of the present invention, a method is used for analyzing a sample, the method comprising: subjecting the sample to modulated electromagnetic radiation scanned through a range of wavelengths covering the entire region of the electromagnetic spectrum from gamma rays (wavelength of less then 10⁻¹¹ meter) to radio wave (wavelength of greater 0.1 meter); measuring a temperature change of the sample during the subjecting step; and measuring a physical expansion of the sample during the subjecting step.

In yet another embodiment of the present invention, a method is used for analyzing a sample, the method comprising: subjecting the sample to electromagnetic radiation; measuring a temperature change of the sample during the subjecting step; and measuring a physical expansion of the sample during the subjecting step.

In yet another embodiment of the present invention, a method is used for generating chemical tomography of sample, the method comprising: subjecting the sample to heat; measuring a temperature change of the sample during the subjecting step; and measuring a physical expansion of the sample during the subjecting step. This method further comprising generating a thermal tomography profile of the sample using the measured temperature change and the measured physical expansion, yielding an improved and more accurate thermal tomography profile over thermal tomography profiles of the prior art.

In yet another embodiment of the present invention, a method is used for generating chemical tomography of a sample, the method comprising: subjecting the sample to electromagnetic radiation; measuring a first temperature change of the sample during the subjecting the sample to electromagnetic radiation step; subjecting the sample to heat; and measuring a second temperature change of the sample during the subjecting the sample to heat step.

In yet another embodiment of the present invention, an apparatus is used for analyzing a sample, the apparatus comprising: subjecting the sample to electromagnetic radiation; measuring a first temperature change of the sample during the subjecting the sample to electromagnetic radiation step; measuring a first physical expansion of the sample during the subjecting the sample to electromagnetic radiation step; subjecting the sample to heat; measuring a second temperature change of the sample during the subjecting the sample to heat step; and measuring a second physical expansion of the sample during the subjecting the sample to heat step.

### OBJECT OF THE INVENTION

An object of the present invention is to use a combination of miniature temperature-sensing probes to measure the multi-dimensional thermal image of a sample.

Another object of the present invention is to use such measurements to perform spectroscopic analyses on individual regions of a sample, selected from scanning probe images obtained with the use of the same thermal probe or otherwise.

Another object of the present invention is to perform a version of scanning thermal microscopy in which the image contrast is determined by variation in the amount of heat absorbed by infrared, or other electromagnetic radiation, to which the sample is exposed, showing a variation in chemical composition.

Another object of the present invention is to perform dispersive infrared microscopy at a high spatial resolution that is not diffraction-limited, using radiation whose wavelength has been restricted to a chosen band within the infrared region of the electromagnetic spectrum and the intensity of which may be modulated over a range of frequencies.

Another object of the present invention is to perform Fourier transform infrared microscopy at a high spatial resolution that is not diffraction-limited, using unfiltered broad-band radiation.

Another object of the present invention is to provide a resistive thermal probe which serves as a point source of heat (in addition to sensing temperature and performing the functions listed in the objects above), such that it can produce the high-frequency temperature modulation that is needed for the user to choose the volume of material being spectroscopically analyzed at each individual location selected.

Another object of the present invention is to construct a three-dimensional image using two-dimensional thermal images (acquired using at least one modulation frequency) and an unmodulated image acquired by either exposing a sample to a source of electromagnetic radiation (monochromated or broad) band, and incorporated into an interferometer so that interferograms can be obtained.

Another object of the present invention is to combine, in one apparatus, the techniques embodied in the above objects with chemical fingerprinting as achieved by micro thermal analysis (Micro-TA).

Another object of the present invention is a method and apparatus to conduct a high spatial resolution chemical analysis of a sample based on measurements of the temperature change and the thermal expansion of a sample subjected to modulated IR light.

Another object of the invention is a method and apparatus to create a high spatial resolution three-dimensional chemical map of a sample by using depth-sensitive measurements of the temperature change and the thermal expansion of a sample subjected to modulated IR light.

### BRIEF DESCRIPTION OF THE DRAWINGS

FIG. 1 is a chart showing the depth profiling conventionally accomplished by PAS as disclosed in the prior art.

FIGS. 2A, 2B and 2C illustrate the use of more than one probe according to one embodiment of the present invention.

FIG. 3 illustrates the use of at least one probe to measure heat expansion in response to IR radiation according to one embodiment of the present invention.

FIG. 4 illustrates a system for generating chemical tomography according to one embodiment of the present invention.

FIG. 5 illustrates a chart describing a method for generating chemical tomography according to one embodiment of the present invention.

### DETAILED DESCRIPTION OF THE INVENTION

In one embodiment of the present invention, high spatial resolution chemical analysis is conducted using a near-field thermal probe measuring temperature changes and thermal expansion in a sample. When dealing with an unknown sample, the measurement of thermal expansion depends on at least the following variables: (a) the coefficient of thermal expansion; (b) the amount of IR radiation absorbed; (c) and the thermal diffusivity of a portion of the material absorbing the radiation and the material surrounding this portion. The values of these variables can be determined using a combination of (i) the thermal imaging; (ii) local thermal expansion coefficient measurement; (iii) local photothermal measurements; and (iv) local expansion produced by absorption of IR radiation carried out at a series of points in such a way that an image can be constructed.

Measuring thermal expansion as a means of detecting the absorption of IR radiation has advantages over measuring temperature change directly with a near-field thermal probe because detecting the absorption of IR radiation is done with a simple conventional passive AFM probe. Conventional AFM probes are more affordable than thermal probes and can achieve higher spatial resolution for topography. However, conventional AFM probes have the disadvantage of being less sensitive to temperature fluctuations than thermal probes and that, by themselves, they cannot provide quantitative measurements of IR absorption, except in the limited and atypical case where the coefficient of thermal expansion of all of the components of a sample are known together with the sample structure.

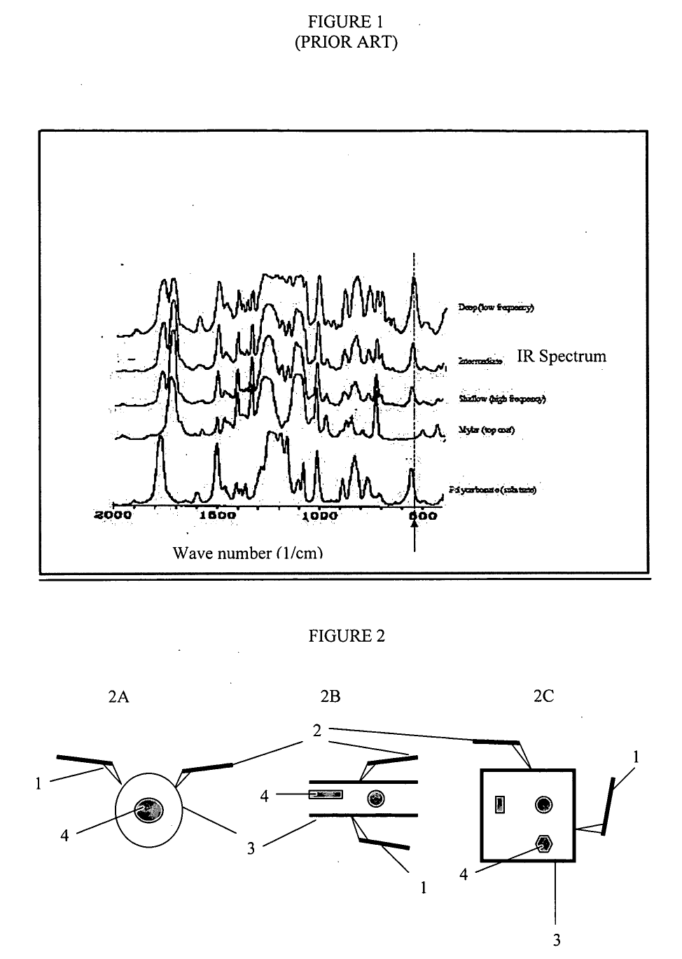

All of these measurements (i.e, (i) the thermal imaging; (ii) local thermal expansion coefficient measurement; (iii) local photothermal measurements; and (iv) local expansion produced by absorption of IR radiation carried out at a series of points in such a way that an image can be constructed), can be made simultaneously or in rapid succession with a near-field thermal probe. Alternatively some could be made with a thermal probe and others made with a conventional AFM probe. FIGS. 2A, 2B and 2C illustrate how, in one embodiment of the present invention, tomography of sample 3, including embedded particles 4, is achieved by making measurements using more than one of either a conventional AFM probe or a high resolution thermal probe, where one probe 1 can act as the emitter while the other 2 can act as the receiver. By moving probes 1 and 2 relative to one another, an array of emitters and receivers can be duplicated. This method can be used for electrical impedance signals and acoustic signals in addition to thermal signals. In all cases tomography could be performed and in some cases more than one type of tomography at the same time.

Furthermore, for thermal tomography with near field probes it is advantageous to use more than one probe not simply because this can save time by using them to image different areas in parallel but also because one can be used as an emitter of thermal waves while the other is used as the receiver. When using only one probe for thermal imaging the same probe must be use for creating the thermal wave and detecting its effects. When using two or more probes one can be used as an emitter while the other is the detector. Furthermore, the relative positions can be varied and so the thermal wave emitted by one probe can be detected at a number of locations by the other. This provides a greater richness of information than can be achieved with a single probe and consequently this assists in tomographic reconstruction of a 3D image of the sample's thermal properties. Also, when the probe is being used to generate thermal waves it also generates, at the same time, a wave caused by thermal expansion. This wave can also be detected by the second probe and this information can assist in the tomographic reconstruction of a 3D image of the samples properties related to thermal expansion and viscoelastic behavior.

The receiver thermal probe 2 is used to map out the multi-dimensional thermal distribution caused by the absorption of the IR radiation. The effects of topography on thermal coupling of the surface to the tip of the probe 2 are corrected for by using a neural net approach, as disclosed in US Patent Publication No. 20030004905, or an equivalent. The data obtained in the above-mentioned method is used to construct a multi-dimensional chemical image of the sample using conventional mathematical techniques.

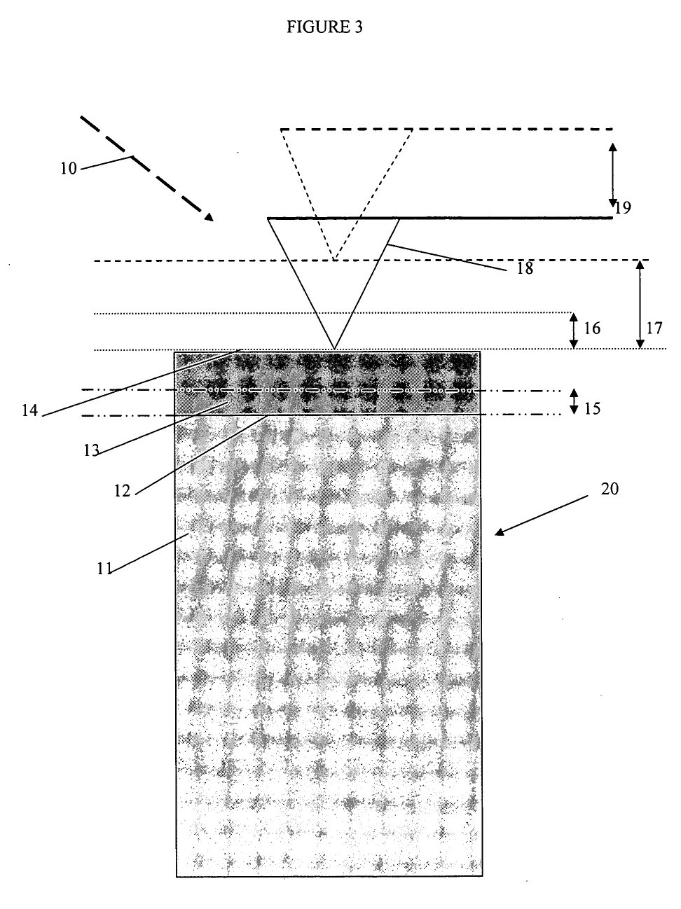

As illustrated in FIG. 3, a two-layer sample comprised of a bottom layer 11 with an upper boundary 12, the bottom layer 11 being 1 unit thick, and a top layer 13 with an upper boundary 14, the top layer being 0.1 units thick, the two layer sample is placed in a scanning thermal microscope with active thermal probe 18. The sample is heated by heating probe 18, or by illuminating the sample with photothermal radiation 10, for example, infrared radiation. The heating or the illumination of the sample causes the sample to increase its temperature and to expand, resulting in total height increase 17 of the sample 20. The total height increase 17, caused by either the heating or the exposure to illumination, is a result of the bottom layer height increase 15 and the top layer height increase 16. As a result of the total height increase 17 of the sample, the probe is displaced by the probe displacement distance 19, because the probe displacement distance 19 is a function of the total height increase 17.

In one embodiment of the present invention, probe 18 is a thermal probe that is used to heat the sample 20, measure the rise in temperature, as well as measure the physical expansion of the sample. In the simple illustration the thermal expansion of the probe is neglected, this effect can be accounted for by suitable calibration. The physical expansion of bottom layer 11 and top layer 13 is measured by measuring the total height increase 17, which is a function of the probe displacement distance 19 as the sample expands upon heat absorption. For purposes of simplicity it is assumed that both bottom layer 11 and top layers 13 have the same coefficient of thermal expansion. The actual expansion of a layer equals the original thickness of the layer times the coefficient of thermal expansion times the increase in temperature. Thus, in a simple case, the ratio of the expansions of two layers equals the ratio of their original thickness (when the coefficient of thermal expansion and the increase in temperature are the same). Thus given the same increase in temperature, layer 11 will expand ten times more than layer 13 since its thickness is ten times greater.

At the same time as measuring the expansion, the thermal probe 18 is measuring the amount of energy required to heat the sample 20, by the measured increase in temperature. In this way the thermal conductivity and/or thermal diffusivity of the sample can be estimated. In conducting thermal tomography, heat measurement can be done in various ways, including (a) modulating the power applied to the tip and measuring the amplitude of the temperature modulation that occurres at the tip; and/or (b) introducing a feedback loop so that the temperature modulation is controlled to a predetermined amplitude, and measuring the electrical power required to achieve this.

The same basic argument applies when bottom layer 11 and top layer 13 are heated in a periodic manner giving rise to a cyclic increase in temperature and a change in total height increase 17. When the sample is heated is such a way that the temperature is modulated with an amplitude of 1° C., the bottom layer 11 (i.e., thicker layer) will expand and contract with an amplitude ten times greater that top layer 13 (i.e., the thin layer) provided the heating is approximately uniform. For this to be the case, the thermal diffusion length implied by the frequency of modulation must be of the same order or greater than the thickness of the layer. The amount of energy required to achieve this temperature modulation will provide an estimate of the thermal diffusivity of the sample.

In the following examples it will be assumed that, when radiation is absorbed, the extinction coefficient is such that the intensity of the radiation is not greatly reduced at it passes through 1 unit depth. Alternative conditions will be discussed later.

### Example 1

Probe 18 is heated with measured amplitude for the temperature modulation of 1° C. at a high modulation frequency at which the thermal diffusion length of the thermal wave is of the order of 0.1 units. The thermal wave does not penetrate much beyond top layer 13 and so the total height increase 17 and the apparent thermal diffusivity is mainly representative of the properties of top layer 13. A second measurement is performed using the heated probe 18 at the same amplitude of temperature modulation at a low frequency at which the thermal diffusion length is of the order of 1 unit. The thermal properties measured are representative of both bottom layer 11 and top layer 13, but mainly representative of the bottom layer 11 because it represents the majority of the material probed by the wave. In the simple case we are considering in this example, the thermal properties of bottom layer 11 and top layer 13 are the same and so the coefficient of thermal expansion and apparent thermal diffusivity are the same at the two frequencies. However, it is noted that, if the coefficient of thermal expansion and the apparent thermal diffusivity were different, the two measurements at the two different frequencies would enable the differences to be determined. With sufficient measurements at sufficient frequencies, the different thicknesses and the different thermal properties of bottom layer 11 and top layer 13 are determined.

### Example 2

The sample is illuminated by a photothermal radiation 1 of a wavelength that is absorbed by the bottom layer 11 but not the top layer 13 with an intensity that is modulated at the high and low frequencies. The intensity of the radiation 1 is adjusted so that a measured temperature modulation with amplitude of 1° C. is achieved. At the high frequency, the amplitude of the temperature expansion is greater than that observed in example 1, because the amplitude of the temperature modulation in bottom layer 11 required to achieve the 1° C. measured amplitude at the surface is greater than 1° C. because the wave is attenuated by top layer 13 which acts as an insulator. This greater than 1° C. amplitude tends to apply throughout the bottom layer 11 and also means that the measured thermal expansion is larger than in example 1. At the lower frequency, the thermal expansion is similar to that observed in example 1 because the top layer 13 has a much lesser attenuation effect at lower frequencies.

### Example 3

The sample is illuminated by a photothermal radiation 1 of a wavelength that is absorbed by the top layer 13 but not by the bottom layer 11. The photothermal radiation is modulated at high and low frequencies. The intensity of the radiation is adjusted so that a measured temperature modulation with amplitude of 1° C. is achieved. At the high frequency, the amplitude of the temperature expansion is be similar to that observed in example 1. At the lower frequency the amplitude of the thermal expansion is similar to that observed in example 1.

Note that in example 2 at the high frequency, without the data from example 1, the data from example 2 cannot be interpreted easily. We simply observe an expansion and have nothing with which to compare it. With the data from example 1, that provides for a method of estimating the coefficient of thermal expansion, it is concluded that the absorbing layer must be the bottom layer 11. This very simple example illustrates two things:

1) To interpret thermal expansion data, reference data are required that are made with probe 18 that can be heated. In this way the thermal diffusivity (and conductivity) and coefficients of thermal expansion for regions of the sample are estimated. Generally, this information is necessary for a quantitative interpretation of photothermal expansion data to reconstruct 3D structural information. Without this information (which would not generally be know in advance), thermal expansion data alone, even at a multiplicity of frequencies, cannot easily be used to provide chemical tomographic image reconstruction

2) Even though the photothermal temperature measurements, combined with Example 1 can be used to create a tomographic reconstruction without using the photothermal expansion data, confirmatory data provided by the expansion data makes interpretation easier and more certain. This is shown by both Example 2 and Example 3. In some cases, the thermal expansion data is of higher quality than the temperature fluctuations data, therefore this additional information is highly useful to achieve tomographic reconstruction.

In the general case, the thermal diffusivity, conductivity, coefficient of extinction and coefficient of thermal expansion are different and the extinction coefficient changes from material to material. Interpreting this complex data to achieve tomographic reconstruction is not trivial but, the measurements made with the near field thermal probe (without IR irradiation) combined with the near field photothermal measurements at different frequencies of modulation of intensity, made at different wavelengths, contain the information necessary to achieve a 3D tomographic reconstruction on a sub-micron scale.

The IR radiation can be modulated in a variety of ways know to those skilled in the art, such as mechanical choppers that rotate blades in front of the beam so that it is ‘chopped’ such that the IR radiation is allowed to reach the sample then blocked, then unblocked etc. as the blade rotates. The frequency of the modulation of intensity of the IR radiation is dictated by the number of blades and the speed of rotation. Alternatively two polarizing filters are used, one is maintained stationary while the other is rotated, this will result in the combination of the filters becoming transparent then gradually darkening before again becoming transparent etc. at a frequency dictated by the speed of rotation. These methods are usually used with monochromated radiation. An alternative method involves the use of a broadband source and an interferometer. The speed at which the mirror is moved in the interferometer dictates the frequency of modulation of the intensity of the radiation. The interferometer can also be used in step-scan mode. This mode is well known to those skilled in the art of IR spectroscopy. The mirror oscillates back and forth over a small interval at a predetermined frequency. The frequency of this oscillation dictates the frequency of modulation of the intensity of the radiation.

The difference between thermal imaging at different modulation frequencies and photothermal imaging at different modulation frequencies can be illustrated by a simple example. Consider a buried particle that is some distance from the surface. Let us consider:

Case 1: The particle has the same thermal diffusivity and conductivity and coefficient of thermal expansion as the surrounding material but it absorbs IR radiation at a wavelength at which the surrounding material is transparent. Thermal imaging where the tip of the probe is heated is incapable of detecting the buried particle either through the measurement of the calorimetric signal or the thermal expansion signal. However, when the sample is irradiated at the appropriate IR wavelength, the particle becomes hot and this causes a temperature fluctuation that can be detected at the surface by the thermal probe. The temperature fluctuation also causes a thermal expansion and this is also detected by the probe. As the frequency of modulation of intensity is increased, the thermal wave becomes weaker at the surface and the relationship between the frequency and degree of attenuation of the temperature fluctuation provides information on how deep the particle is buried, provided an estimation of the thermal diffusivity and expansion coefficient of the sample can be made. This is possible from the thermal (heated tip) imaging.

Case 2: This particle has a different thermal diffusivity and conductivity and a different coefficient of thermal expansion from the surrounding material, and it absorbs IR radiation at a wavelength at which the surrounding material is transparent. Thermal imaging where the tip of the probe is heated is able to detect the buried particle both through the measurement of the calorimetric signal and the thermal expansion signal. When the sample is irradiated at the appropriate IR wavelength, the particle becomes hot and this causes a temperature fluctuation that can be detected at the surface by the thermal probe. The temperature fluctuation also causes a thermal expansion that is also detected by the probe. As the frequency of modulation of intensity is increased, the thermal wave becomes weaker at the surface and the relationship between the frequency and degree of attenuation of the temperature fluctuation provides information on how deep the particle is buried, provided an estimation of the thermal diffusivity of the sample can be made. This is possible from the thermal imaging.

In all cases, the information from the thermal (heated tip) imaging is used together with the information from the photothermal (heated sample) images, both of which are used as input to the solution of the inverse problem. Thus, an accurate 3D position of the particle can be determined and information on its chemistry can be determined from the wavelength at which it absorbs IR radiation. Only thermal or only photothermal information cannot, by themselves, provide sufficient information for this accurate 3D tomographic reconstruction to be achieved.

Making initial measurements with a near-field thermal probe followed by thermal expansion measurements (with a conventional AFM probe or with a high resolution thermal probe) has at least the following advantages: (i) topography can often be measured with higher resolution that with the near-field thermal probe; (ii) in some cases, the spatial resolution for photothermal imaging will be higher; and (iii) costs will be lower because conventional AFM probes are much cheaper than thermal probes.

Making both the thermal and physical expansion measurements with the thermal probe has at least the following advantages: (i) it is quicker and more convenient as the number of times an area needs to be imaged is smaller and the probe does not need to be changed; (ii) difficulties in finding and imaging exactly the same area and/or aligning different images taken at different times are eliminated; and (iii) in this way, the use of initial measurements using a thermal probe can greatly improve the interpretation of photothermal expansion images.

Having both the thermal images and the photothermal images provides an extra piece of information that is used in solving an inverse problem to construct an accurate and/or more robust three-dimensional tomographical image of the distribution of materials within the sample. More than simply acquiring sub-surface images of a sample, in one embodiment of the present invention, a processor is used to run a set of instructions that execute an algorithm for constructing a multidimensional tomographical image representing the various properties of the sample.

If only temperature measurement had been used in the above-mentioned example, it would not have been clear whether one or both layers have absorbed the IR radiation. The additional information provided by the expansion measurement with both the heated tip and the IR radiation indicates whether one or both layers absorb a particular wavelength of IR radiation providing an indication as to whether they have the same chemical composition.

In practice, most measurements are more complex because of temperature gradients, etc. However, as appreciated by those skilled in the art, a more accurate and/or robust three dimensional image can be generated by exploiting the additional information provided by the thermal expansion measurements in addition to the thermal (due to thermal excitation) and photothermal (due to electromagnetic radiation excitation) measurements.

An apparatus according to one embodiment of the present invention comprises: at least one thermal probe; hardware and software to sense and/or to control the probe temperature; at least one apparatus for scanning probe microscopy; at least one sources of infrared radiation; at least one apparatus for infrared spectroscopy; at least one apparatus for modulating the source of infrared radiation and detecting the thermal signatures arising from this modulated radiation; apparatus for focusing and directing the beam of radiation so that the area around the thermal probe is bathed in the radiation so that if the sample absorbs the radiation the local temperature will increase; a computer readable media containing instructions representing mathematical algorithms to reconstruct a multi dimensional chemical image from the observed thermal images.

The source of electromagnetic radiation is either a tunable laser or a source of thermal radiation as used in standard procedures for dispersive infrared spectroscopy or for Fourier transform infrared spectroscopy.

The apparatus for infrared spectroscopy can be dispersive or Fourier transform. The dispersive type of spectroscopy apparatus comprises a wavelength selector and modulator. In a dispersive type spectroscopy, one or more of the following elements are used: (a) a monochromator and mechanical chopper; (b) an acousto-optic tunable filter; (c) an acousto-optic modulator plus filter; (d) an electro-optic modulator; (e) a liquid crystal tunable filter; and (f) holographic filter. In a Fourier transform type of spectroscopy apparatus, a radiation detector is not used.

A purpose of the apparatus for infrared spectroscopy is focusing and directing the beam of radiation (received from either the thermal source or from the wavelength selector and monochromator), and directing the beam in concentrated form onto the area of the sample that is spatially scanned by the probe of the scanning microscope.

In a preferred embodiment of the present invention, two or more active thermal probes are used in combination to acquire AC thermal images at a multiplicity of frequencies either sequentially or simultaneously. A multi-dimensional thermal image is then constructed using various mathematical methods. Then, the sample is illuminated by an IR laser tuned to a selected wavelength and pulsed at a selected frequency T. An alternative to using a laser is using a broadband source of illumination and an interferometer to attain the modulation used in the following step. Next, the radiation is modulated at a variety of different frequencies in order to obtain a new thermal image at each frequency. Another possibility is to use the technique of time resolved spectroscopy where a pulse of radiation is used and spectral measurements are made at a predetermined time after the pulse.

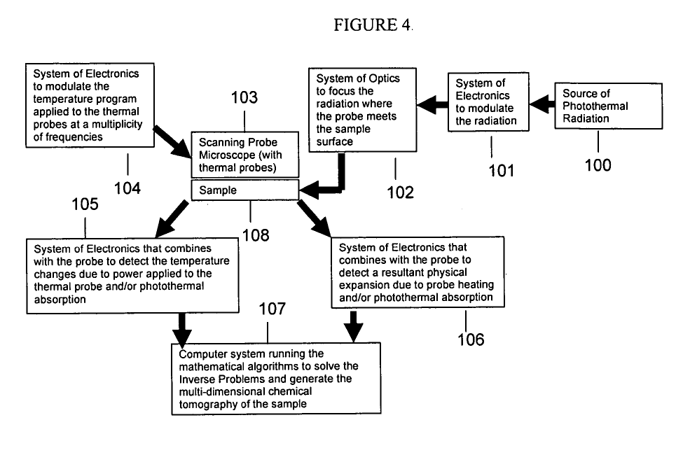

FIG. 4 is an illustration of the system for conducting localized infrared spectroscopic micro-tomography according to one embodiment of the present invention, the system comprising: a scanning probe microscope 103 that uses one or more active near-field thermal probes to generate a multi dimensional thermal image; a system of electronics 104 to modulate the temperature program applied to the thermal probes at a multiplicity of frequencies; a source of photothermal radiation 100 that is scanned through the range of wavelengths of interest; a system of electronics 101 to modulate the intensity of the photothermal radiation source; a system of electronics 105 that combines with the probe to detect the temperature changes due to power applied to the thermal probe and/or photothermal absorption at this modulated frequency; a system of optics 102 that enables photothermal radiation to be focused in the region where a probe meets a sample surface 108; a system of electronics 106 that combines with the probe to detect a resultant physical expansion due to probe heating and/or photothermal absorption; and a computer system running mathematical algorithms to reconstruct a multi dimensional chemical tomography of the sample 107.

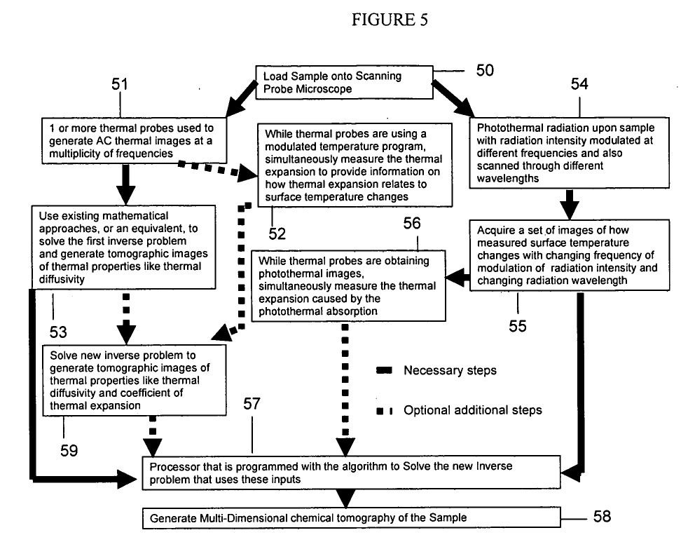

FIG. 5 is an illustration of the method for localized infrared spectroscopy, according to one embodiment of the present invention, using a combination of physical expansion, temperature change measurements, and chemical micro-tomography, the method comprising: scanning a sample in a scanning probe microscope 50 using one or more active thermal probes at a multiplicity of frequencies to get the thermal images 51 and the thermal expansion information 52 and feed these inputs to existing algorithms to solve the inverse problem 53 to generate tomographic images of thermal properties like thermal diffusivity and yet another inverse problem 59 which takes into account information from 53 and the thermal expansion information 52 to give thermal tomographic images of thermal diffusivity (more accurately than that in 53 and additionally gives tomographic images of the coefficient of thermal expansion; illuminating the sample using photothermal radiation at a multiplicity of wavelengths and modulation frequencies 54; detecting a resultant thermal distribution 55 due to photothermal absorption at different modulation frequencies and wavelengths and simultaneously detecting thermal expansion 56 due to photothermal absorption; and use a Processor that is programmed with an algorithm 57 to solve the new Inverse problem that takes as inputs the thermal distribution 55 and physical expansion 56 due to photothermal absorption together with the tomographic images of thermal properties like thermal diffusivity and coefficient of thermal expansion 53 in order to generate a multi-dimensional chemical tomography 58 of the sample.

What is claimed as new and desired to be protected by Letters Patent of the United States is:

1. A method of analyzing a sample, the method comprising:
subjecting the sample to electromagnetic radiation;
measuring a temperature change of the sample during the subjecting step; and
measuring a physical expansion of the sample during the subjecting step.

2. The method according to claim 1, wherein the subjecting step further comprises subjecting the sample to electromagnetic radiation over a range of frequencies.

3. The method according to claim 2, wherein the subjecting step further comprising modulating an intensity of the electromagnetic radiation.

4. The method according to claim 1, wherein the subjecting step further comprising modulating an intensity of the electromagnetic radiation.

5. The method according to claim 1, wherein the electromagnetic radiation is infrared radiation.

6. The method according to claim 1, wherein at least one near field probe is used to conduct measurements.

7. The method according to claim 1, wherein two near field probes are used to conduct the method.

8. The method according to claim 1, further comprising:
measuring the temperature change of the sample simultaneously with measuring the physical expansion of the sample.

9. The method according to claim 1, further comprising:
generating a chemical tomography profile of the sample using the measured temperature change and the measured physical expansion.

10. A method of analyzing a sample, the method comprising:
subjecting the sample to heat;
measuring a temperature change of the sample during the subjecting step; and
measuring a physical expansion of the sample during the subjecting step.

11. The method according to claim 10, wherein the subjecting step further comprising modulating an intensity of the heat.

12. The method according to claim 11, wherein the heat is modulated at a certain frequency.

13. The method according to claim 10, wherein the heat is emitted by a near field probe.

14. The method according to claim 10, wherein at least one near field probe is used to conduct measurements.

15. The method according to claim 10, further comprising using two near field probes, wherein a first near field probe is used as an emitter of heat and second near field probe is used as a detector.

16. The method according to claim 10, further comprising:
measuring the temperature change of the sample simultaneously with measuring the physical expansion of the sample.

17. The method according to claim 10, further comprising:
generating a thermal tomography profile of the sample using the measured temperature change and the measured physical expansion.

18. A method of analyzing a sample, the method comprising:
subjecting the sample to electromagnetic radiation;
measuring a first temperature change of the sample during the subjecting the sample to electromagnetic radiation step;
subjecting the sample to heat; and
measuring a second temperature change of the sample during the subjecting the sample to heat step.

19. The method according to claim 18, wherein the subjecting the sample to electromagnetic radiation step further comprises subjecting the sample to electromagnetic radiation over a range of frequencies.

20. The method according to claim 18, wherein the subjecting the sample to electromagnetic radiation step further comprising modulating an intensity of the electromagnetic radiation.

21. The method according to claim 18, wherein the subjecting the sample to heat step further comprising modulating an intensity of the heat.

22. The method according to claim 18, wherein the electromagnetic radiation is infrared radiation.

23. The method according to claim 18, wherein at least one near field probe is used to conduct measurements.

23. The method according to claim 18, further comprising using two near field probes to conduct the method.

24. The method according to claim 18, further comprising:
generating a chemical tomography profile of the sample using the first temperature change and the second temperature change.

25. A method of analyzing a sample, the method comprising:
subjecting the sample to electromagnetic radiation;
measuring a first temperature change of the sample during the subjecting the sample to electromagnetic radiation step;
measuring a first physical expansion of the sample during the subjecting the sample to electromagnetic radiation step;
subjecting the sample to heat;
measuring a second temperature change of the sample during the subjecting the sample to heat step; and
measuring a second physical expansion of the sample during the subjecting the sample to heat step.

26. The method according to claim 25, wherein the subjecting the sample to electromagnetic radiation step further comprises subjecting the sample to electromagnetic radiation over a range of frequencies.

27. The method according to claim 25, wherein the subjecting the sample to electromagnetic radiation step further comprising modulating an intensity of the electromagnetic radiation.

28. The method according to claim 25, wherein the subjecting the sample to heat step further comprising modulating an intensity of the heat.

29. The method according to claim 25, wherein the electromagnetic radiation is infrared radiation.

30. The method according to claim 25, wherein at least one near field probe is used to conduct measurements.

31. The method according to claim 25, wherein two near field probes are used to conduct method.

32. The method according to claim 25, further comprising:
generating a chemical tomography profile of the sample using the first temperature change, the first physical expansion, the second temperature change and the second physical expansion.

33. An apparatus for analyzing a sample, the apparatus comprising:
a source of electromagnetic radiation, the source subjecting the sample to the electromagnetic radiation; and
at least one device for measuring a temperature change of the sample and a physical expansion of the sample.

34. The apparatus according to claim 33, wherein the source of electromagnetic radiation subjects the sample to electromagnetic radiation over a range of frequencies.

35. The apparatus according to claim 33, further comprising a modulator for modulating an intensity of the electromagnetic radiation.

36. The apparatus according to claim 34, further comprising a modulator for modulating an intensity of the electromagnetic radiation over a range of frequencies.

37. The apparatus of claim 33, wherein the device is a near field probe.

38. The apparatus according to claim 33, wherein the electromagnetic radiation is infrared radiation.

39. The apparatus according to claim 33, wherein the device measures a temperature change of the sample simultaneously with a physical expansion of the sample

40. The apparatus of claim 33, further comprising a computer readable medium containing a set of instructions for determining a chemical tomography of the sample using at least the physical expansion and the temperature change measurements.

41. An apparatus for analyzing a sample, the apparatus comprising:
a source of heat, the source subjecting the sample to heat; and
at least one device for simultaneously measuring a temperature change and a physical expansion of the sample.

42. The apparatus of claim 41 further comprising a modulator for modulating an intensity of the heat over a range of frequencies.

43. The apparatus of claim 41 wherein the device is a near field probe.

44. The apparatus of claim 41 wherein the source of heat is a first near field probe and wherein the at least one device is a second near field probe.

45. An apparatus for analyzing a sample, the apparatus comprising:
a source of electromagnetic radiation, the source subjecting the sample to the electromagnetic radiation;
a source of heat, the source subjecting the sample to the heat; and
a near field probe for measuring a first temperature change due to the electromagnetic radiation and a second temperature change due to the heat.

46. The apparatus of claim 45 further comprising a modulator for modulating over a range of frequencies an intensity of the heat.

47. The apparatus of claim 45 further comprising a modulator for modulating over a range of frequencies an intensity of the electromagnetic radiation.

48. The apparatus of claim 45 further comprising a modulator for modulating the electromagnetic radiation over a range of frequencies.

49. The apparatus of claim 45, further comprising a computer readable medium containing a set of instructions for determining a thermal tomography profile of the sample using at least the first temperature change and the second temperature change.

50. An apparatus according to claim 45, wherein the first temperature change and the second temperature change are acquired simultaneously.

51. An apparatus for analyzing a sample, the apparatus comprising:
a source of electromagnetic radiation, the source subjecting the sample to the electromagnetic radiation;
a source of heat, the source subjecting the sample to the heat;
a near field probe for measuring a first temperature change due to the electromagnetic radiation, a first physical expansion due to the electromagnetic radiation, a second temperature change due to the heat, and a second physical expansion due to heat.

52. The apparatus of claim 51 further comprising a modulator for modulating over a range of frequencies an intensity of the heat.

53. The apparatus of claim 51 further comprising a modulator for modulating over a range of frequencies an intensity of the electromagnetic radiation.

54. The apparatus of claim 51 further comprising a modulator for modulating the electromagnetic radiation over a range of frequencies.

55. The apparatus of claim 51, further comprising a computer readable medium containing a set of instructions for determining a thermal tomography profile of the sample using at least the first temperature change, the first physical expansion, the second temperature change and the second physical expansion.

56. An apparatus according to claim 51, wherein the first temperature change, the first physical expansion, the second temperature change, and the second physical expansion are acquired simultaneously.

57. A system for determining a chemical tomography of a sample, the system comprising:
means for irradiating the sample;
means for measuring a value of a temperature change of the sample;
means for measuring a value of a physical expansion of the sample; and
means for generating the chemical tomography of the sample using at least the value of the temperature change and the value of the physical expansion.
